(19) United States
(12) Patent Application Publication
(10) Pub. No.: US 2013/0292594 A1
(43) Pub. Date: Nov. 7, 2013

(54) WEAR COMBINATION FOR STARTER AIR VALVE

(71) Applicants: Kevin M. Rankin, Windsor, CT (US); Francis P. Marocchini, Somers, CT (US); Matthew Capozzi, Enfield, CT (US)

(72) Inventors: Kevin M. Rankin, Windsor, CT (US); Francis P. Marocchini, Somers, CT (US); Matthew Capozzi, Enfield, CT (US)

(73) Assignee: HAMILTON SUNDSTRAND CORPORATION, Windsor Locks, CT (US)

(21) Appl. No.: 13/460,927

(22) Filed: May 1, 2012

(51) Int. Cl. F16K 31/44; F16K 25/00; F16K 1/42

(52) U.S. Cl. 251/231; 251/359; 251/368

(57) ABSTRACT

A wear combination includes a first surface formed by a nickel-based hardface alloy and a second surface formed by steel. The second surface is disposed in frictional contact with the first surface.

### BACKGROUND

The invention relates to a wear couple and more particularly to a valve for a turbine starter.

Turbine starters include turbines that require a supply of air to operate properly. This air supply is provided via duct work upstream from the turbine through which an air flow pathway is defined. A valve is normally disposed along this pathway for modulating an amount of the air flow permitted to proceed to the turbine. Where more air flow is required, the valve is opened and, where it is necessary to limit the flow, the valve is closed.

The valves for modern turbine starters are typically controlled by pneumatic actuation systems. In case of a pneumatic system failure, a manual wrenching lever allows the valve to be opened manually. In order to facilitate valve open and close feedback, the wrenching lever interfaces with a switch. When the wrenching lever is manually rotated (in the event of a pneumatic failure), the switch is depressed to open the valve.

It is necessary for the wrenching lever to be constantly loaded in frictional contact against the switch throughout the life of the valve. Due to these design criteria, a significant amount of wear occurs on both the wrenching lever and the switch in high vibration environments as the result of the frictional contact. The wear is due to relative vibratory motions (dithering) between both components, which necessitates replacement of both components in service. In some cases the wear can potentially result in failure of the manual wrenching feedback system.

### SUMMARY

A wear combination includes a first surface formed by a nickel-based hardface alloy and a second surface formed by steel. The second surface is disposed in frictional contact with the first surface.

In another aspect, a valve component includes a metallic base material with a nickel-based hardface alloy coating applied over the base material to form a contact surface. The contact surface has a surface roughness of about 16 micro inches (0.41 micro meters) Ra or less.

In yet another aspect, a starter valve includes a wrenching lever and a switch. The wrenching lever has a paddle that includes a first surface. The switch is disposed adjacent the wrenching lever and includes a plunger with a second surface. The first surface is formed by a nickel-based hardface alloy and the second surface is disposed in frictional contact with the first surface.

### BRIEF DESCRIPTION OF THE DRAWINGS

FIG. 1 is a perspective view of one embodiment of a starter valve for a turbine starter showing a manual wrenching lever and a switch.

FIG. 2 is a perspective view of a portion of the wrenching lever of FIG. 1 showing a base of the wrenching lever and a paddle.

### DETAILED DESCRIPTION

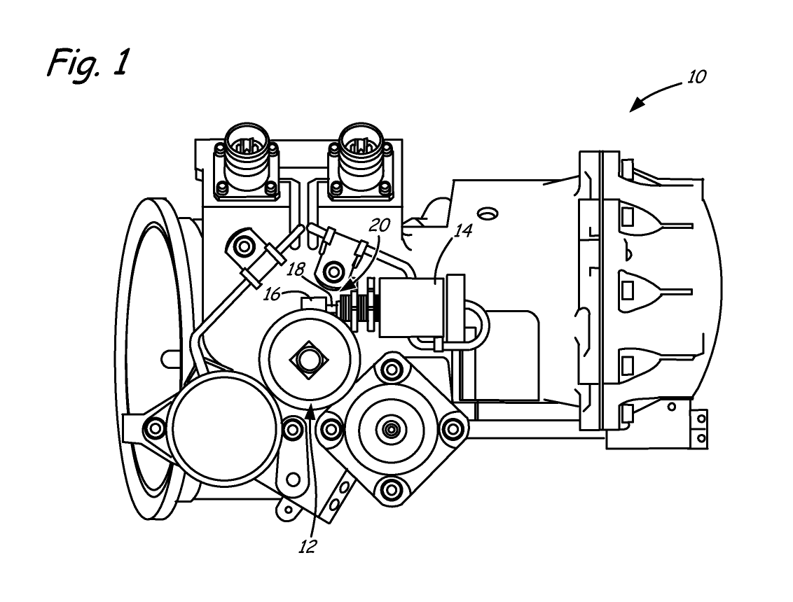

FIG. 1 shows a perspective view of one embodiment of a starter valve 10 for a turbine starter. The valve 10 includes a manual wrenching lever 12 and a switch 14. In the embodiment shown, wrenching lever 12 includes a paddle 16, and switch 14 includes a plunger 18. Together paddle 16 and plunger 18 form a wear combination 20.

As illustrated wrenching lever 12 is mounted to the exterior of valve 10. Wrenching lever 12 is capable of manual rotation relative to valve 10 through known means such as a tool which is inserted in a square head or hex head recess formed in wrenching lever 12.

Plunger 18 extends from switch 14 and is movable relative to the remainder thereof. In one embodiment, plunger 18 has a generally cylindrical shape with an outer surface. Both the plunger and outer surface are comprised of a stainless steel such as a 17-4PH stainless steel or an AISI 303 stainless steel in one embodiment.

Switch 14 is mounted to the exterior of valve 10 in close proximity to wrenching lever 12 such that plunger 18 is in frictional contact with the outer surface of paddle 16. When necessary, the manual rotation of wrenching lever 12 causes a corresponding rotation of paddle 16 and depression of plunger 18. This action actuates switch 14 which operates to open components within the interior of valve 10.

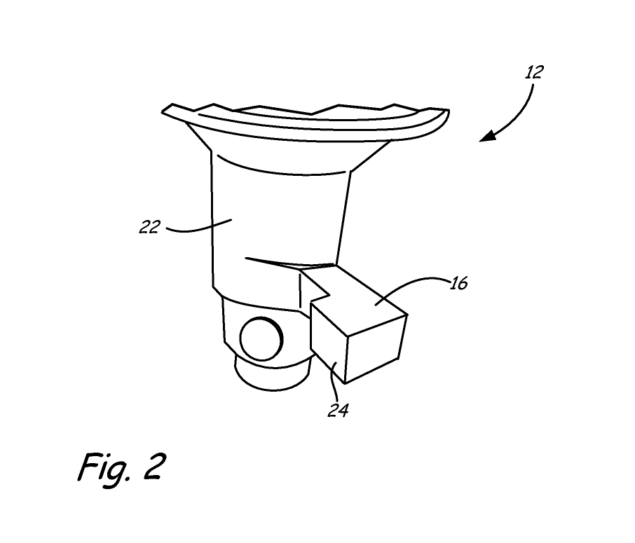

FIG. 2 shows one embodiment of wrench lever 12 and paddle 16. As shown, paddle 16 has a base 22 and a contact face 24. Paddle 16 extends from base 22 of wrenching lever 12. In the embodiment shown, paddle 16 extends generally perpendicular to an axis of rotation (not shown) of wrenching lever 12. As was shown in FIG. 1, contact face 24 comprises one side of paddle 16. In the embodiment shown, contact face 24 comprises a generally flat uniform surface which contacts and interfaces with the outer surface of plunger 18 (FIG. 1). Contact face 24 may have different geometries in other embodiments.

In one embodiment, contact face 24 is formed by a nickel-based hardface alloy. One such nickel-based hardface alloy is comprised of 0.3-1.0% carbon, 3.5-5.5% silicon, 12.0-18.0% chromium, 3.5-5.5% iron, 1% max cobalt and 2.50-4.50% boron (with the remaining balance comprised of nickel) by weight percentage. In one embodiment, the nickel-based hardface alloy comprises a coating that is applied over a suitable base material. Base material comprises other portions of wrench lever 12 such as paddle 16. Suitable base materials can comprise various alloys such as an austenitic steel, nickel based alloy, or a cobalt based alloy. Generally base material can comprise any alloy that does not experience a martensitic phase transformation (which would result in a volumetric change and cracking of the coating) upon cooling. In one embodiment, hardface alloy is applied directly to martensitic steel by thermal spray methods including high velocity oxy-fuel coating spraying and/or laser cladding as these methods limit the bulk temperature rise of the base material. In other embodiments, base material can comprise steel, titanium, or aluminum instead of stainless steel.

The hardface coating can be applied on the base material by various methods including puddle welding, spray welding, plasma spray, high velocity oxi-fuel spray, thermal spray, laser cladding, and various other deposition and diffusion processes. The nickel-based hardface alloy that comprises contact face 24 is subsequently machined to a smoothness of about 16 micro inches (0.41 micro meters) Ra or less.

Controlled-amplitude dither testing demonstrates the effectiveness of utilizing the nickel-based hardface alloy to form contact face 24 of wear combination 20 between paddle 16 and plunger 18. More particularly, utilizing the nickel-based hardface alloy to form contact face 24 (with plunger 18 formed of AISI 303 stainless steel) reduced total combined volumetric wear between paddle 16 and plunger 18 by 50 to 80 percent over various test temperatures when compared to a baseline wear combination of 17-4PH stainless steel (paddle and face) and AISI 303 stainless steel (plunger). The nickel-based hardface alloy can be mechanically removed and reapplied easily resulting in reduced maintenance costs. Additionally, wear combination 20 exhibits not only reduced wear but preferential wear (i.e. wrenching lever 12, which is more easily replaceable, experiences wear rather than plunger 18).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wear combination comprising:
a first surface formed by a nickel-based hardface alloy; and
a second surface formed by a steel, wherein the second surface is disposed in frictional contact with the first surface.

2. The wear combination of claim 1, wherein the steel comprises a stainless steel.

3. The wear combination of claim 1, wherein the nickel-based hardface alloy comprises a coating formed over a base material.

4. The wear combination of claim 3, wherein the base material comprises one of a steel, nickel based alloy, aluminum, titanium, or a cobalt based alloy.

5. The wear combination of claim 1, wherein the first surface has a roughness of about 16 micro inches (0.41 micro meters) Ra or less.

6. The wear combination of claim 1, further comprising:
a wrenching lever having a paddle; and
a switch disposed adjacent the wrenching lever, wherein the switch includes a plunger;
wherein the paddle includes the first surface, and wherein the plunger includes the second surface.

7. A valve component comprising:
a metallic base material; and
a nickel-based hardface alloy coating applied over the base material to form a contact surface;
wherein the contact surface has a roughness of about 16 micro inches (0.41 micro meters) Ra or less.

8. The valve component of claim 7, wherein the base material comprises one of a steel, nickel based alloy, aluminum, titanium or a cobalt based alloy.

9. The valve component of claim 7, wherein the valve component comprises a wrenching lever for a starter valve.

10. The valve component of claim 8, further comprising:
a switch disposed adjacent the wrenching lever; and
wherein the wrenching lever has a paddle that includes the contact surface and wherein the switch has a plunger that includes a second surface that contacts the contact surface.

11. The valve component of claim 10, wherein the second surface is comprised of a stainless steel.

12. A starter valve comprising:
a wrenching lever having a paddle that includes a first surface; and
a switch disposed adjacent the wrenching lever, wherein the switch includes a plunger with a second surface;
wherein the first surface is formed by a nickel-based hardface alloy, and wherein the second surface is disposed in frictional contact with the first surface.

13. The starter valve of claim 12, wherein the paddle extends from a base portion of the wrenching lever and extends generally perpendicularly with respect to an axis of rotation of the wrenching lever.

14. The starter valve of claim 13, wherein the contact face comprises one side of the paddle, and wherein the contact face forms a generally flat uniform surface.

15. The starter valve of claim 12, wherein the second surface is formed by a stainless steel.

16. The starter valve of claim 12, wherein the nickel-based hardface alloy comprises a coating formed over a base material.

17. The starter valve of claim 16, wherein the base material comprises one of a steel, nickel based alloy, aluminum, titanium or a cobalt based alloy.

18. The starter valve of claim 12, wherein the first surface has a roughness of about 16 micro inches (0.41 micro meters) Ra or less.
